(19) United States
(12) Patent Application Publication
(10) Pub. No.: US 2003/0090102 A1
(43) Pub. Date: May 15, 2003

(54) Direct mailing device with an anti-microbial agent

(76) Inventor: Thomas Becker, Willow Springs, IL (US)

Correspondence Address: SONNENSCHEIN NATH & ROSENTHAL, Wacker Drive Station, Sears Tower, P.O.BOX 061080, Chicago, IL, 60606-1080, US

(21) Appl. No.: 10/037,188

(22) Filed: Nov. 9, 2001

(51) Int. Cl. G09F 1/00

(52) U.S. Cl. 283/56

(57) ABSTRACT

This invention relates to an advertisement device or a mailable device for direct mailing to a recipient, and in particular to an advertisement device or a mailable device for direct mail delivery to a recipient. The advertisement device has a panel, with a back side and a front side, at least one of the back side and the front side adapted to receive delivery information, and a thickness sufficient to maintain integrity of the panel. The panel also includes an anti-microbial agent. A method of delivering an advertisement device to a recipient having a panel, the panel having a back side and a front side, at least one of the back side and the front side adapted to receive delivery information, and a thickness sufficient to maintain integrity of the panel is also provided. The panel also includes an anti-microbial agent. An advertisement device system for direct mail delivery to a recipient, having a panel, with a back side and a front side, at least one of the back side and the front side adapted to receive delivery information, and a thickness sufficient to maintain integrity of the panel; and means for applying delivery information. The panel or mailable device also includes an anti-microbial agent. The anti-microbial agent at least partially inhibits the growth or accumulation of undesirable biological agents on the panel or mailable device.

### FIELD OF THE INVENTION

This invention relates to advertising and, more particularly, to an advertisement device with an anti-microbial agent for direct mail delivery to a recipient.

### BACKGROUND OF THE INVENTION

Marketers for centuries have attempted to grasp the attention of potential consumers by using whatever technology, service or infrastructure available. Most of these techniques, however, fail to provide any long-term impact on the purchasing decisions of the consumer. One method used to attract customers is to utilize the surface of retail display surfaces or display mediums, such as counter tops, or the interior or exterior surfaces of a wall or window of a store, a door, a building, or a vehicle, etc. However, this approach generally cannot impact purchasing decisions made at home, the work place, or any other location other than the retail location where advertisement is displayed.

Another method used to attract customers is mass mailing of printed material such as brochures, catalogs, postcards, advertisements enclosed in envelopes, and the like. However, these forms of advertisement are expensive to produce, handle, and/or deliver when compared to the results they obtain. Moreover, advertisements mailed in envelopes require not only the expense of complex machinery or labor to stuff the envelopes, but postage costs can also be expensive. Mailing brochures have similar problems in that they are expensive to produce and require machinery or people to fold and secure the brochures before they are mailed Catalogs are also expensive to produce and mail.

Another approach to attract customers is conventional print advertising. Conventional print advertising is accomplished by printing stationary non-moveable information and pictures on magazines, newspapers, brochures, flyers, posters, billboards, signs, wrapper, boxes, etc. Many conventional print advertisements and packages do not attract the attention of customers, and are ill suited for mass mailing.

Conventional print advertising materials or devices delivered to a recipient via a delivery service may be susceptible to accumulating or carrying biological agents, such as microbes, bacteria, fungi, yeast, molds, and the like during shipping and handling in the delivery process Such biological agents typically develop and grow fast, and can be harmful to the recipient (depending upon the type of biological agents that accumulate on the particular advertising material or device) because they may potentially inflict disease or other biological harm upon the recipient. It would, therefore, be desirable to provide print advertising materials or a mailing device and method for making the same that at least partially inhibits biological agents from forming, accumulating or developing thereon.

It is, therefore, desirable to provide an improved advertisement device that overcomes one or more of the preceding problems, and which takes advantage of the availability of direct mail delivery services for mailing advertisements to consumers, and which may further take advantage of the availability of display surfaces controlled by and frequently seen by the consumer, such as countertops, walls, windows of buildings, vehicles and the like, for advertising products and/or services. Further, it is desirable to provide a mailable device and method for making same that at least partially inhibits biological agents from forming, accumulating or developing thereon.

### SUMMARY OF THE INVENTION

This invention relates to an advertisement device for direct mail delivery to a recipient. The advertising device has a panel, having a back side, a front side, at least one of the back side and the front side adapted to receive delivery information, and a thickness sufficient to maintain integrity of the panel. The panel includes an anti-microbial agent, such as in an ink used to print upon the panel or in a coating upon at least one surface of the panel. The present invention also relates to a method of delivering an advertisement device to a recipient having a panel, having a back side, a front side, at least one of the back side and the front side adapted to receive delivery information, and a thickness sufficient to maintain integrity of the panel. The panel includes an anti-microbial agent, such as in an ink used to print upon the panel or in a coating upon at least one surface of the panel. This invention also relates to an advertisement device system for direct mail delivery to a recipient, comprising a panel having a back side, a front side, at least one of the back side and the front side of the panel adapted to receive delivery information, and a thickness sufficient to maintain integrity of the panel, and means for applying delivery information. The panel includes an anti-microbial agent, such as in an ink used to print upon the panel or in a coating upon at least one surface of the panel.

### BRIEF DESCRIPTION OF THE DRAWINGS

The components in the figures are not necessarily to scale, emphasis instead being placed upon illustrating the principals of the invention. Moreover, in the figures, like reference numerals designate corresponding parts throughout the different views.

FIG. 1 is a front view of one example of the advertisement device;

FIG. 2a is a cross-sectional view of the advertisement device of FIG. 1,

FIG. 2b is a cross-sectional view of the advertisement device of FIG. 1, with a means to detachably attach the advertisement device to a surface;

FIG. 3 is a front view of another example of the advertisement device, which has frangible edges and a cutout;

FIG. 4a is a cross-sectional view of the advertisement device of FIG. 3,

FIG. 4b is a cross-sectional view of the advertisement device of FIG. 3, with a means to detachably attach the advertisement device to a surface;

FIG. 5 is a schematic view of an example of a method of delivering to a recipient an advertisement device by direct mail delivery;

FIG. 6 is a schematic view of an example of an advertisement device system for direct mail delivery to a recipient;

FIG. 7 is a front view of an alternate embodiment of the advertisement device with a mechanism to hold the device with respect to a surface;

FIG. 8 is a front view of an alternate embodiment of the advertisement device with a mechanism to carry another item therewith to a recipient;

FIG. 9a is a front view of a mailable device having a design imprinted and/or a coating applied on at least a portion thereof; and

FIG. 9b is a back view of the mailable device of FIG. 9a.

### DETAILED DESCRIPTION OF THE INVENTION

While the present invention may be embodied in many different forms, several specific embodiments are discussed herein with the understanding that the present disclosure is to be considered only as an exemplification of the principles of the invention, and it is not intended to limit the invention to the embodiments illustrated. Where the invention is illustrated herein with particular reference to front and back, or top and bottom, or left and right, it is understood that any other orientation along any axis of the advertisement device can, if desired, be substituted for the embodiments as herein described.

The present invention is generally directed to an advertisement device for direct mail delivery to a recipient. The advertising device comprises a panel, having a back side, a front side, at least one of the back side and the front side adapted to receive delivery information, and a thickness sufficient to maintain integrity of the panel. The panel also includes an anti-microbial agent. A method of delivering an advertisement device to a recipient is also provided. The method comprises printing an advertisement related to a product and/or a service on a panel having a back side, a front side, at least one of the front side and the back side adapted to receive delivery information, and a thickness sufficient to maintain integrity of the panel; applying the delivery information to the panel; and delivering the advertisement device to a recipient by a direct delivery mail service. The panel also includes an anti-microbial agent. An advertisement device system for direct mail delivery to a recipient is also provided. The advertisement device system comprises a panel, having a back side, a front side, at lease one of the back side and the front side adapted to receive delivery information, and a thickness sufficient to maintain integrity of the panel; and a means for applying delivery information. The panel also includes an anti-microbial agent. The panel may take a shape related to a theme of the product or the service being advertised. Further, this shape may be formed using a partially perforated cutout embedded in the panel.

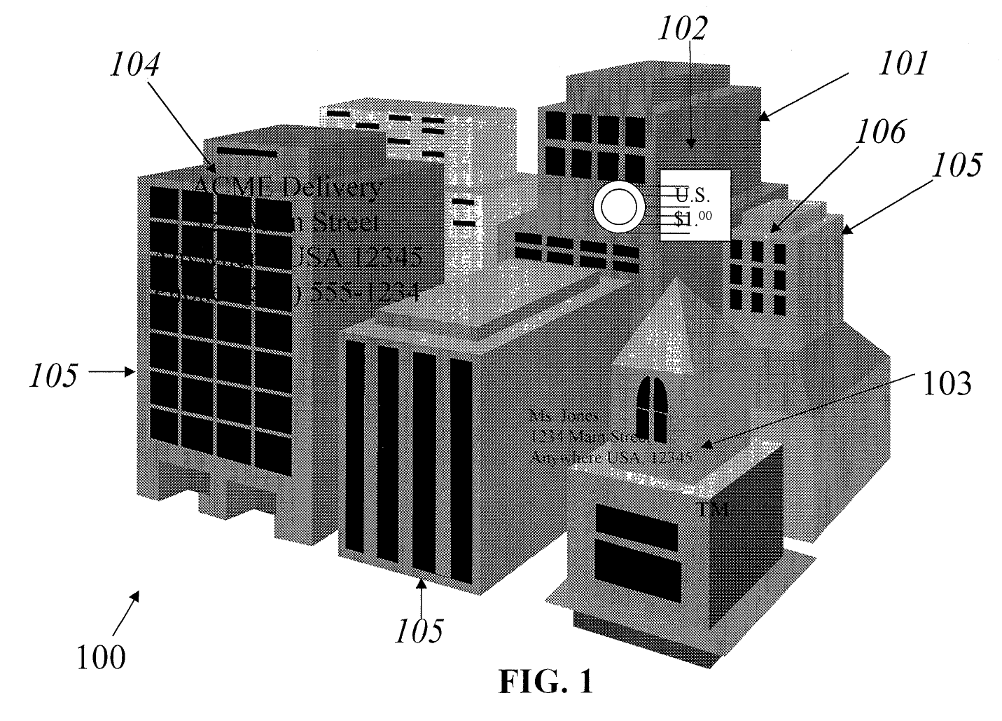

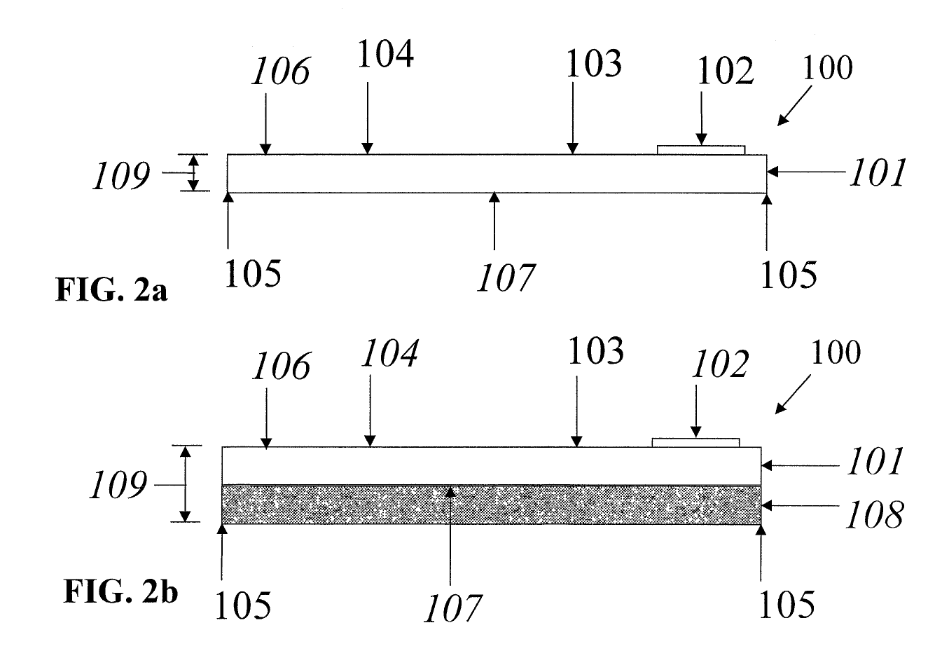

The panel (101, 201) is a panel made of any conventional material, typically of natural origin, such as from paper, cardboard, and the like. Referring to FIG. 1, the front side of an advertising device (100) is shown having a panel (101), with a front surface (106); a theme related to Acme delivery service (a fictitious delivery company); a printed pattern and a shape resembling a set of buildings, which represents the fictitious trademark and service theme of Acme Delivery; contact information (104) for Acme Delivery printed on the front surface of the panel (101); an edge (105); delivery information (103) printed on the front surface (or the back surface in alternate embodiments) of the panel (101); and postage (102) for direct mail delivery Referring to FIG. 2a, the advertising device (100) of FIG. 1 is shown in cross section, having a back surface (107), and a thickness (109) sufficient to maintain integrity of the panel (101). Referring to FIG. 2b, a second example of the type of advertising device depicted in FIG. 1 is shown in cross section. As this cross-section shows, this example has (in addition to many of the attributes) means for detachably or permanently fastening (108) the advertising device to a display surface, and a thickness (109) sufficient to maintain integrity of the panel (101).

The panel (101, 201) is preferably of sufficient thickness to maintain integrity thereof during direct mail delivery to a recipient and, thus, through its continued use and display by the recipient. In one embodiment, the panel (101) has a thickness of between about 0.001 mm to about 10.0 mm. However, it is contemplated that the panel (101) of the advertisement device (100) could be between about 0.05 mm to about 2.0 mm in thickness or even between about 0.175 mm to about 0.75 mm in thickness, the thickness being essentially a design choice. The panel (101, 201) can be flexible or inflexible. The panel (101, 201) can include paper, covered, layered, laminated, coated or the like, in such a manner as to achieve some or all of the benefits provided by the materials.

The panel (101, 201) of the advertisement device (100, 200) will generally be printed with alphanumeric and graphic information. The use of certain panels may make it necessary to utilize specialized printing materials and techniques, such as silk screening printing processes, sheet fed or web offset printing, web letter press printing, gravure printing, or printing utilizing ink jet printing technology. The printing inks are generally formulated for printing on the respective materials for enhanced adhesion and practical durability. Examples of printing inks include those manufactured and sold commercially by the companies Toyo Ink America LLC (with an office at 910 Sylvan Avenue, Englewood Cliffs, N.J. 07632 201-568-8660), Kohl & Madden (with an office at 222 Bridge Plaza South, Ft. Lee, N.J. 07024 201-886-1203), Handschy Industries (with an office at 13601 S. Ashland Avenue, Riverdale, Ill. 60628 708-597-7990) and Inx International Ink Company (with an office at 651 Bonnie Ln., Elk Grove Village, Ill. 60007 847-981-9399). A portion or the entire front and/or back surface of the panel (101, 201) of the advertising device (100, 200) can be printed, herein termed the “print pattern” The print pattern is typically a pattern of dots, lines or other plurality of discrete elements and/or a grid pattern surrounding a plurality of unprinted areas. A panel can contain names, words (for example, delivery or contact information), symbols, phrases, terms, advertising, such as a multicolor logo, or a design, such as a picture, emblem or logo, and/or other pictures or scenes, etc., including for example, trade names, trademarks, and/or service marks. One or both sides of the panel can receive printing or coating with appropriate materials. Delivery or contact information generally contains the name (or “current resident”) and address of the recipient and postage where, for example, the United Stated Postal Service is used.

The panel (101, 201) may also have at least one printed pattern printed thereon related to a theme of a product and/or a service; and/or a shape related to a theme of a product and/or a service; and/or a cutout embedded in the panel related to a theme of a product and/or a service. The cutout may be a geometric (e.g. square, trapezoidal, oval, elliptical, circular, triangular, rectangular, polygonal) or a contoured shape. Contoured shapes can resemble, for example, the shape of any object, person, place or thing such as historical figures, celebrities, animals, electronic or mechanical devices; vehicles, appliances; toys; personal items; an item of commerce (e.g. credit cards, or trademarks, and food items). The shape of a panel or cutout, however, is not critical. And a panel or cutout can be shaped in many forms too numerous to be listed herein, but are nonetheless contemplated to be included within the scope of the present invention.

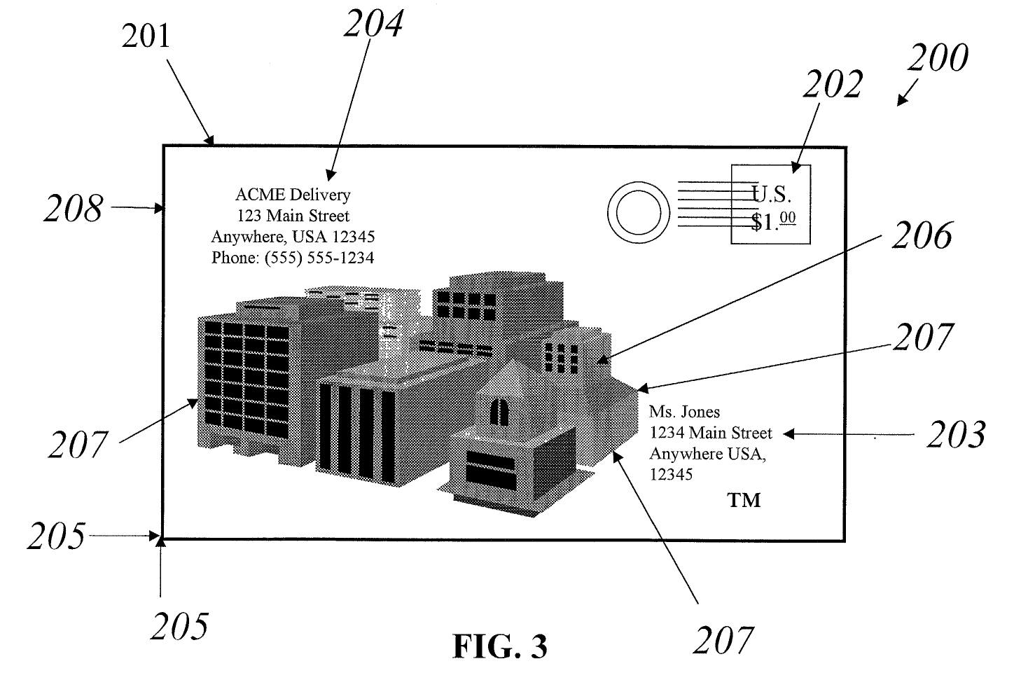

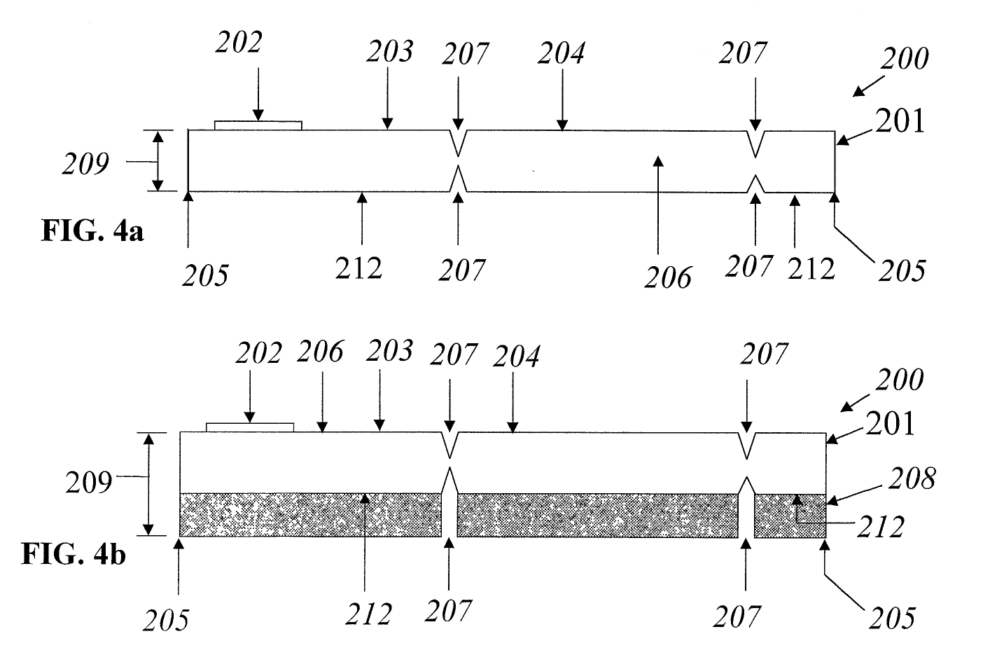

In one approach, the shape may be solely pre-configured to facilitate formation. Referring to FIG. 3, the front side of an advertising device is shown having a panel (201), having a cutout (207) with a frangible edge delineated by a score or a cut; an edge (205); delivery information (203) printed on one of the front surface (207) or the back surface (hidden from view in FIG. 3) of the panel (201); postage (202) for direct mail delivery; and a cutout (207) having a theme related to Acme delivery service, and contact information (204) for Acme Delivery printed on the surface of the cutout (207). Referring to FIG. 4a, the advertising device of FIG. 3 is shown in cross section, having a back surface (212), a thickness (209) sufficient to maintain integrity of the panel during direct mail delivery to the recipient, and a cutout (207) having an area on the front surface (206) of the cutout (207) adapted to receive contact information for Acme Delivery, and a back surface (212). FIG. 4b shows the types of the advertising device with means for detachably fastening (208) the advertising device to a display surface applied on the back surface of the frangible edge and the cutout (207).

In one embodiment, an anti-microbial agent is added to the printing material, such as the ink, used for imprinting upon the panel or mailing device to help at least partially inhibit the growth, development or accumulation of undesirable biological agents thereon. Such undesirable biological agents may include, for example, microbes of bacteria, yeast, fungi, mold, and the like. To inhibit their growth, development or accumulation, an anti-microbial agent, such as a predetermined chemical or compound that can serve such purpose, is incorporated into the printing material of the panel or mailing device. Various types of anti-microbial agents are available commercially for such purpose, such as those sold by Microban Products Company, which has an office at 11515 Vanstory Drive, Huntersville (N.C.) 28078 (704-875-0806) and AgION Technologies L.L.C., which has an office at 60 Audubon Road, Wakefield, Mass. 01880 (781-224-7100). Some of these anti-microbial agents, or chemicals, can be added to many types of printing materials and inks. The anti-microbial agents are added to the printing materials or inks typically in a predetermined ratio or amount prior to using it for imprinting upon the panel, and they usually last in the printing material for most of the lifetime of the product. The anti-microbial agents are typically odorless, tasteless and colorless, and therefore do not alter the physical characteristics of the panel or mailing device, or the imprinting thereupon, in any significant manner. Accordingly, in such embodiment, the panel or mailing device may be more desirable for public use as it is less likely to carry or deliver disease-causing microbes or biological agents to the recipient because the growth, development or accumulation thereof on the device is reduced considerably.

In another embodiment, a coating is applied upon at least one surface of the panel or mailing device, and the coating includes an anti-microbial agent. Preferably, however, substantially all surfaces of the panel or mailing device includes the aforementioned coating applied thereon. The relatively narrow edges of the panel or mailing device, for example, may not have the coating applied thereon, but the comparatively broader front surface and back surface thereof will therefore comprise the aforementioned substantially all surfaces of the panel or mailing device. Such anti-microbial agents are also commercially available from the two companies mentioned above, and perform a substantially identical function as discussed above for the anti-microbial agents added to the printing materials. In such embodiment, the panel or mailing device may likewise be more desirable for public use as it is less likely to carry or deliver disease-causing biological agents to the recipient because the growth, development or accumulation thereof on the device is reduced considerably.

In an alternate embodiment, an anti-microbial agent is added to the printing materials or ink, and an anti-microbial agent is also added to a coating applied to at least one surface of the panel. It will be appreciated that such embodiment offers dual protection against biological agents on the device, and should accordingly be more desirable. However, it is recognized that such embodiment may carry a comparatively higher manufacturing cost because of the added cost of adding anti-microbial agents to both the printing materials and the coating thereon.

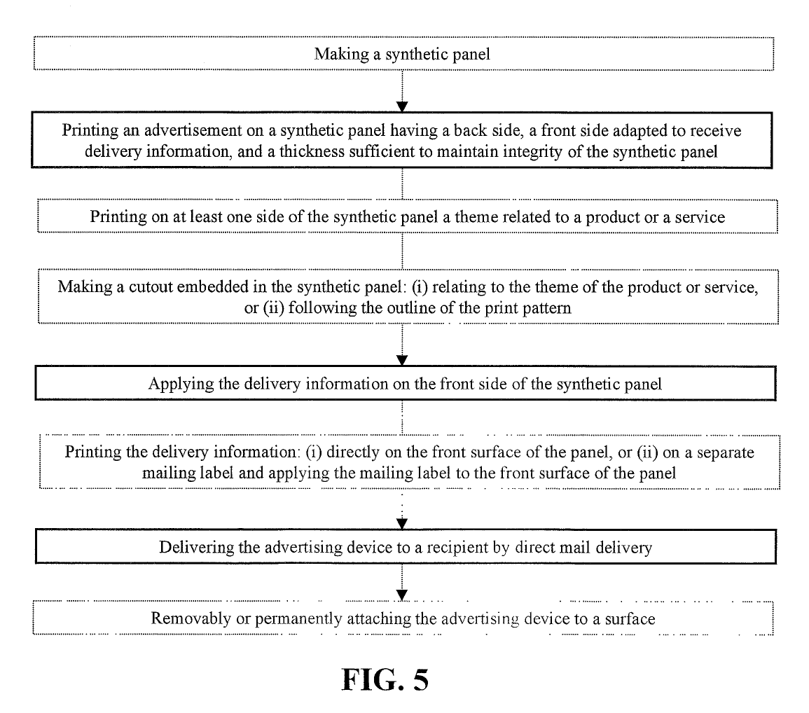

A method of delivering an advertisement device by direct mail delivery to a recipient is also provided. Referring to FIG. 5, one example of a method of delivering an advertisement device by direct mail delivery to a recipient is shown. The method of FIG. 5 may include printing an advertisement on a panel having a back side, a front side, at least one of the back side and the front side adapted to receive delivery information, and a thickness sufficient to maintain integrity of the panel; applying the delivery information to at least one of the front side and the back side of the panel; and delivering the advertising device to a recipient by the direct mail delivery. The panel also includes an anti-microbial agent. The delivery information may be printed directly on the surface of the panel, or the delivery information may be printed on a separate mailing label and then applied to a surface of the panel. The advertisement device may also have printing on at least one side of the panel a theme related to a product and/or a service A cutout may also be embedded in the panel and may have a shape relating to a theme of a product and/or a service. The cutout may also follow the outline of the print pattern. The method may also include making a panel. The method may also include removably or permanently attaching the advertisement device to a surface for display. The method also includes adding an anti-microbial agent to the panel, such as by adding an anti-microbial agent to the ink used for imprinting upon the panel or applying a coating comprising an anti-microbial agent on at least one surface of the panel, or preferably upon substantially all surfaces of the panel.

The term “direct mail delivery” refers to the delivering of an advertisement device to a recipient using a courier or delivery service that transports and delivers documents, packages, cargo, parcels, and/or freight by land, sea and/or air. Such delivery services that can be used in the present invention, including but not limited to, mail delivery services such as the United States Postal Service, Federal Express Inc. (FedEx®), United Parcel Service, Inc. (UPS®), Airborne Express, Inc., and RPS, Inc., to name a few.

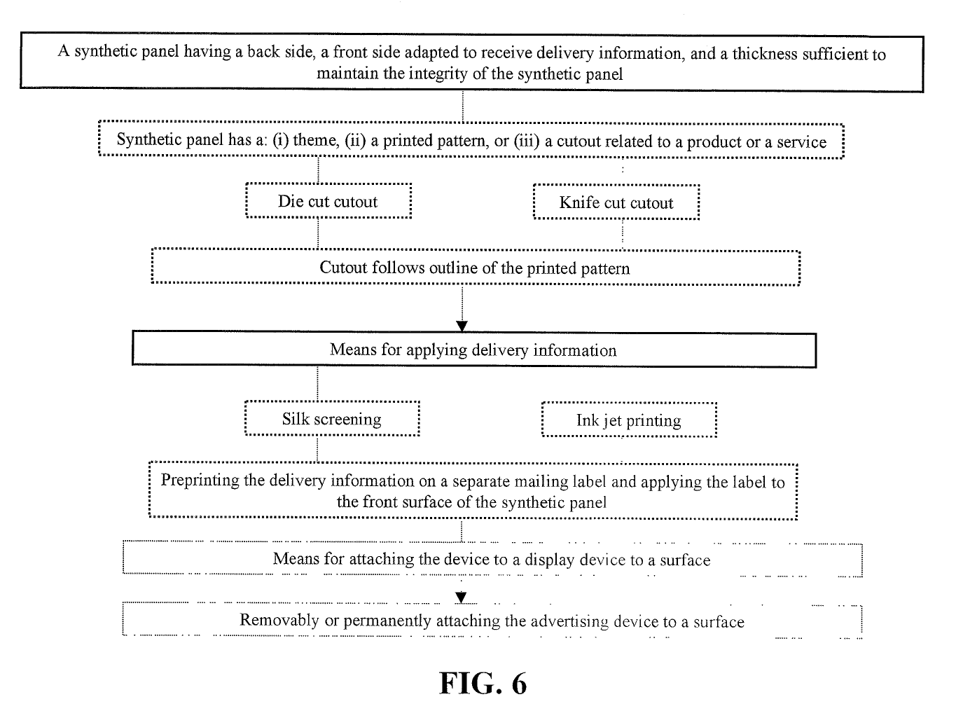

An advertising device system for direct mail delivery to a recipient is also provided. Referring to FIG. 6, one example of an advertising device system is shown. The advertisement device system of FIG. 6 may include a panel, having a back side, a front side, at least one of the back side and the front side adapted to receive delivery information, and a thickness sufficient to maintain integrity of the panel; and means for applying delivery information. The panel also includes an anti-microbial agent. The means for applying the delivery information may include silk screening, sheet fed printing, web offset printing, web letter press printing, gravure printing, and/or ink jet printing. Also, the means for applying the delivery information may include preprinting the delivery information on a separate mailing labeled and applying the label to a surface of the panel. The advertising device system may also include a panel with a theme related to a product and/or a service. The advertising device system may also have a panel with a printed pattern related to the theme of a product and/or a service; and a cutout embedded in the panel related to a theme of the product and/or a service. The cutout may be die cut or knife cut, for example. The cutout may even be implemented when the panel is manufactured, which can be done in any one of the various ways known therefor in the art. The cutout may also follow the outline of the print pattern. The advertising device system may also include a means to removably or permanently attach the device to a surface with an adhesive, double sided tape, a loop fastener, a pile fastener, a magnet, magnetized sheeting, magnetic tape, a screw, a snap, and/or fastening tape.

The panel may also be provided with an overlaid pattern, graph, or charted surface, for example by silk-screening, to facilitate the presentation of information, or have a printed chalk compatible surface for use with chalk. Similarly, the sheet may be selected for use with dry-erase markers to provide further utility to the advertisement device.

In another embodiment of the present invention, the advertisement device is adapted for mounting on a display surface or medium, such as a wall, window or a door, etc. Such mounting is accomplished with means for fastening the advertisement device to a display surface. Such means include, but are not limited to, adhesive, heat lamination, double sided tape, loop fasteners, magnets, magnetized sheeting, magnetic tape, screws, snaps, fastening tape, buttons and button holes, stitches, suction cups, hook and eyes, zipper, static cling material, lock and key, and pile fasteners.

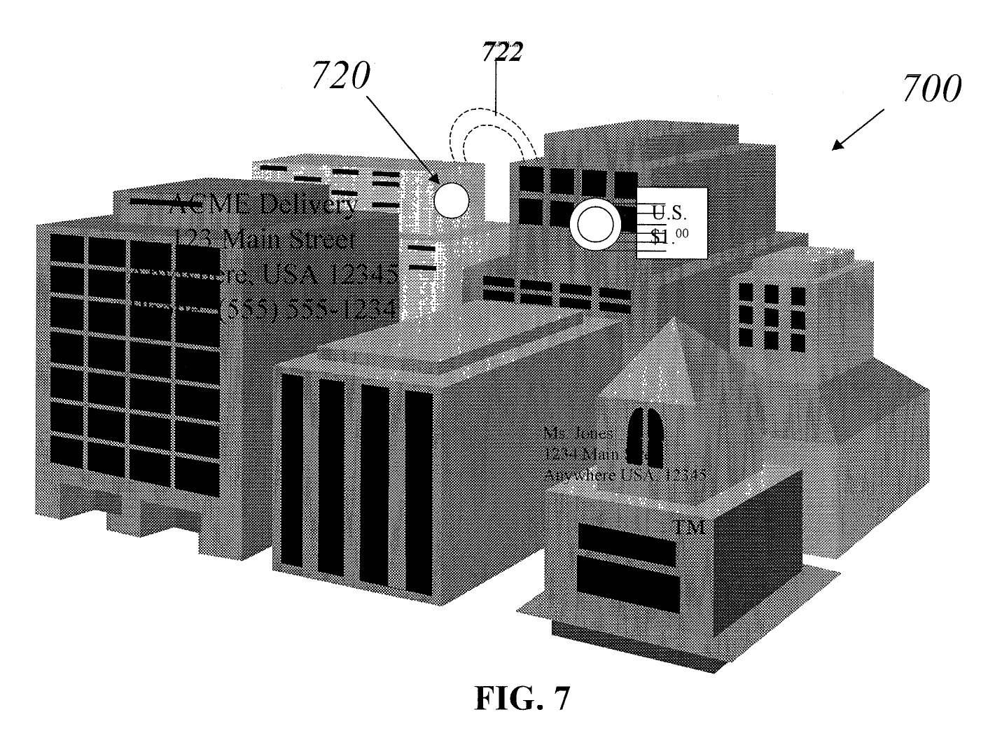

Referring to FIG. 7, a front view of an alternate embodiment of the advertisement device with a mechanism to hold the device with respect to a surface is shown. The advertisement device (700) essentially includes a mechanism, or means, for holding the device (700) with respect to a surface, such as a substantially vertical surface like a wall, to display the advertisement device (700). This feature adds to the permanence effect of the advertisement device (700) for the recipient thereof. The mechanism for holding the device (700) with respect to a surface may be one of any number of types, such as a hole (720) in the device (700). It will be appreciated that the device (700) can be held with respect to a surface by inserting a nail or a hook through the hole (720). Further in this embodiment, the hole (720) may include a grommet (not shown), such as a metal or rubber grommet, lining the periphery of the hole (720) to protect the edges of the hole (720) from getting damaged during use. In another embodiment, device (700) includes a hanging extension (722) for holding the device (700) with respect to a surface. The hanging extension (722) is shown in phantom in FIG. 7, and includes an opening that may be cooperatively engaged with a nail, a hook, or the like. The hanging extension (722) may be a part of the device (700) formed along with the panel when it is formed, thereby being integral with the device (700). In another embodiment, the hanging extension (722) may be an additional component substantially rigidly attached to the panel, such as a string, relatively thick thread-like material, or the like. Accordingly, those skilled in the art will appreciate that a number of different means may be implemented in the device (700) to serve the purpose of displaying the device from a vertical surface without departing from the spirit and scope of the present invention, and therefore all such embodiments are recognized and anticipated and it is intended that all such embodiments are covered by the claims hereof.

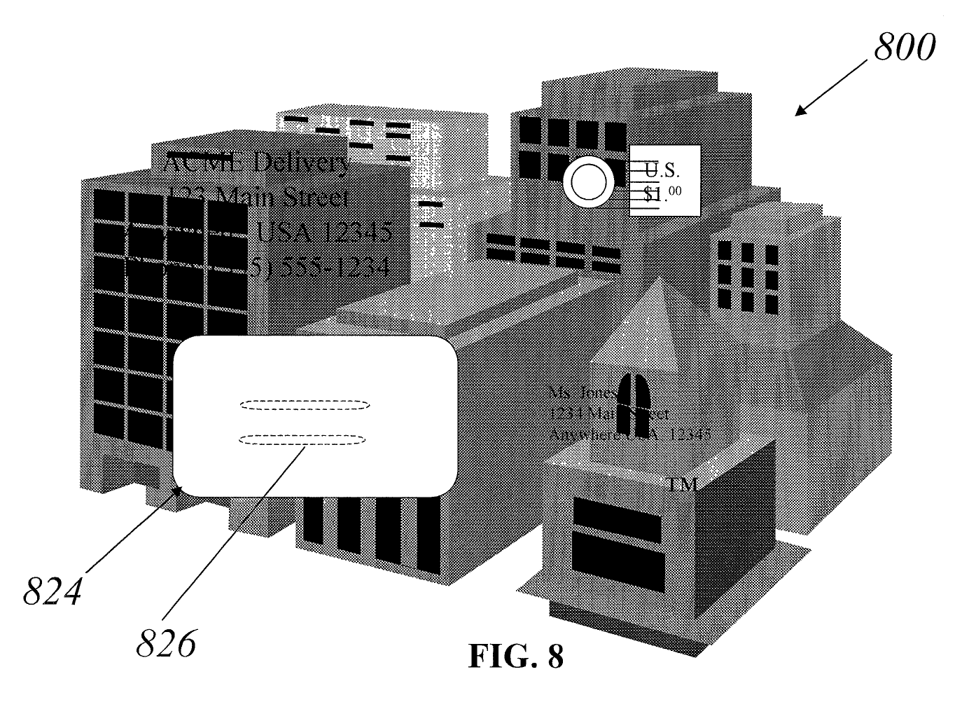

Referring to FIG. 8, a front view of an alternate embodiment of the advertisement device with a mechanism to carry another item to an intended recipient is shown. Sometimes, it might be desirable to send an extraneous item (824), such as a plastic card, or a credit card, or a relatively flat magnetic item displaying some relevant images and/or alphanumeric information, etc., to the recipient along with the device (800). Typically, such extraneous item (824) will be relatively flat and thin, such as a coupon, a credit card, a refrigerator-magnet, etc., although it is recognized and anticipated that it may also have a different shape and/or dimension. The extraneous item (824) may be removably or permanently affixed to the device (800). In one embodiment, the extraneous item (824) is removably affixed to the device (800). In such embodiment, the extraneous item (824) may be removably adhered to the device (800) by one or more strips of an adhesive (826) (shown in phantom in FIG. 8) whereby the extraneous item (824) can be selectively peeled off from the device (800) by the recipient. The implementation and composition of such strips of adhesive (826) is known in the art. Alternatively, the extraneous item (824) may be shrink-wrapped or laminated with the device (800), whereby it can be selectively unwrapped and/or detached from the device (800) by a user. The overlamination, for example, could be with a material, such as a plastic overlaminating film, that serves to hold the extraneous item (824) with respect to the device (800). In another embodiment, the extraneous item (824) is substantially permanently attached to the device (800). In such embodiment, for example, the extraneous item (824) may include a magnetic surface, whereby the device (800) may be magnetically attached to a magnetic-attracted surface, such as the door of a refrigerator.

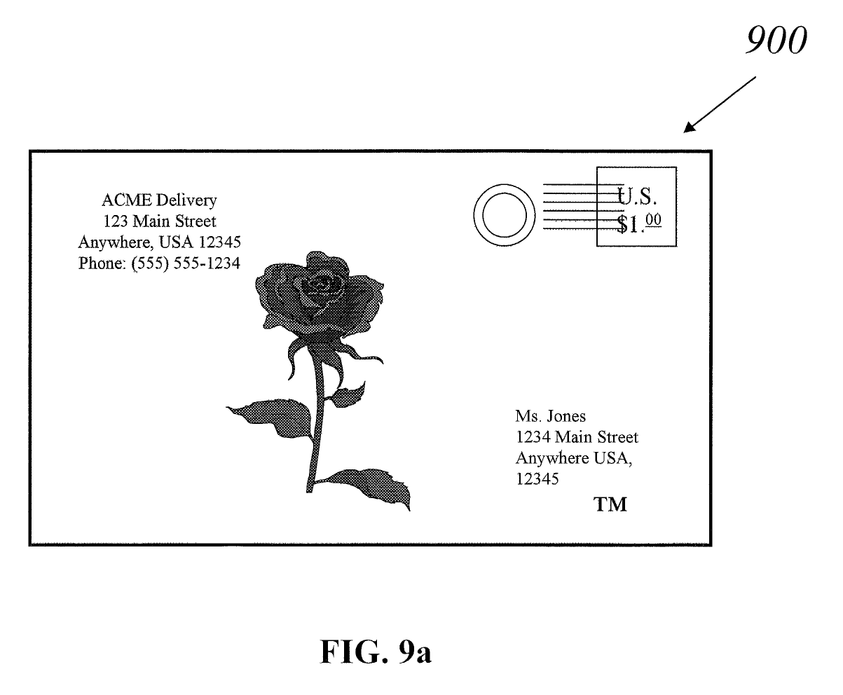

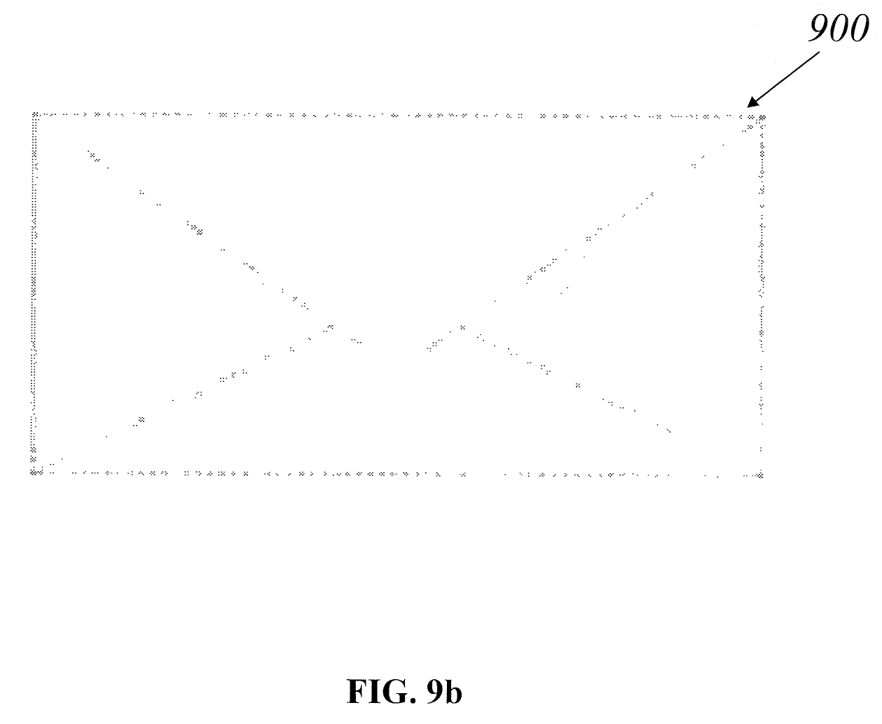

Referring to FIGS. 9a and 9b, a front view of a mailable device 900 having a design imprinted and/or a coating applied on at least a portion thereof, and a back view thereof, respectively, are shown. It is recognized and anticipated that the teachings of the present invention are applicable to most mailable devices. The mailable device will typically have a body, such as a conventional envelope, a post card, or a bulk-pack envelope, with at least one side for applying delivery information. The mailable device has an anti-bacterial agent either temporarily or substantially permanently associated with it. A conventional envelope, for example, can include a coating applied on at least one surface thereof, or preferably on substantially all surfaces thereof, wherein the coating includes an anti-microbial agent. In another embodiment, an ink used for imprinting a pattern or design on at least a portion of the mailable device, such as a conventional envelope, includes an anti-microbial agent. In such embodiments, the ink and imprinted pattern or design can cover a substantial portion of the body of the mailable device to increase the surface covered by the anti-microbial agent in the ink In another embodiment, a majority of the surface may include a shade or coloring, once again increasing the surface covered by the anti-microbial agent in the ink. It will be appreciated that such mailable devices are desirable for public use as they are less likely to carry or deliver disease-causing microbes or biological agents to the recipient because the growth, development or accumulation thereof on the device is reduced considerably.

As used herein, the term “embedded” refers to a process of carving or creating a graphic or alphanumeric design in a panel of the advertisement device using techniques known by those skilled in the art, such as by using a die, a knife or a laser cutting tool to cut or score a graphic or alphanumeric design in a panel. The carving or creating can be on one or both sides of the panel, and of sufficient depth to allow a recipient to remove the frangible edge that results from the embedding process, and of a depth to maintain the integrity of the cutout during direct mail delivery to a recipient.

As used herein, the term “adhesive” refers to a material that provides or promotes adhesion. Adhesive material that can be used in the present invention include, but is not limited to, glue; paste; cement; and pressure-sensitive adhesive including tackified rubber adhesive, such as natural rubber, olefin, silicone, polyisoprene, polybutadiene, polyurethane, styrene-isoprene-styrene and styrene-butadiene-styrene block copolymers, and other elastomers; and tackified or untackified acrylic adhesives such as copolymers of isooctylacrylate and acrylic acid, which can be polymerized by radiation, solution, suspension, or emulsion techniques; and polymeric binders such as ethylene-vinyl-acetate, ethylene-methyl-acrylate, ethylene-ethyl-acrylate, ethylene-butyl-acrylate, and ethylene-methacrylicacid. The adhesive may be a crosslinked adhesive that gives high shear strength. This cross-linkage may be caused by radiation with or without a chemical cross-linking agent.

Furthermore, in some approaches to this method, in order to improve adhesion of the adhesive layer to a panel, the panel can be pretreated prior to applying the adhesive in one or more of the following ways: corona discharge, plasma discharge, flame treatment, electron beam irradiation, ultraviolet radiation, acid etching, or chemical priming. Such pretreatments can be carried out with or without reactive chemical adhesion promoters such as hydroxyethyl acrylate or hydroxyethyl methacrylate, or other reactive species of low molecular weight.

As used herein, the term “pile fastener” refers to fastening tape generally comprising a strip of nylon with a surface of minute hooks that fasten to a corresponding strip with a surface of uncut pile. Velcro™ is the most commonly used pile fastener, and includes for example, Velcro™ matting and Velcro™ loops, and Velcro™ Comp and Velcro™ loops.

Although the invention has been described with respect to specific embodiments and examples, it should be appreciated that other embodiments utilizing the concept of the present invention are possible without departing from the scope of the invention. The present invention is defined by the claimed elements, and any and all modifications, variations, or equivalents that fall within the spirit and scope of the underlying principles.

What is claimed is:

1. An advertisement device for direct mail delivery to a recipient, comprising:
a panel having a back side, a front side, at least one of said back side and said front side adapted to receive delivery information, and a thickness sufficient to maintain integrity of the panel; and
an anti-microbial agent on said panel.

2. The device of claim 1, wherein the delivery information is printed directly on a surface of said front side or said back side of said panel.

3. The device of claim 1, wherein said delivery information is preprinted on a separate mailing labeled and applied to a surface of said front side or said back side of said panel.

4. The device of claim 1, wherein said panel comprises a theme related to at least one of a product and a service.

5. The device of claim 4, wherein said panel has at least one of a printed pattern related to the theme of the product or the service, and a cutout embedded in said panel related to the theme of the product or the service.

6. The device of claim 5, wherein said cutout is die cut.

7. The device of claim 5, wherein said cutout is knife cut.

8. The device of claim 5, wherein said cutout is implemented when said panel is manufactured.

9. The device of claim 5, wherein said cutout follows an outline of the print pattern.

10. The device of claim 5, wherein the printed pattern comprises at least one of a name, a word, a symbol, a phrase, a term, a logo, a design, a picture, an emblem, and a scene

11. The device of claim 10, wherein the printed image is multicolored.

12. The device of claim 10, wherein the design comprises at least one of an advertisement, a trade name, a trademark, and a service mark.

13. The device of claim 10, wherein the printed pattern is substantially the same on the front and back of said panel.

14. The device of claim 10, wherein an ink is used to print said printed pattern, and said ink comprises said anti-microbial agent.

15. The device of claim 1, wherein said panel comprises a coating on at least one surface thereof, and said coating includes said anti-microbial agent.

16. The device of claim 15, wherein said panel comprises said coating on substantially all surfaces thereof.

17. The device of claim 1, wherein said panel comprises paper or cardboard.

18. The device of claim 1, further comprising a means to attach the device to a surface.

19. The device of claim 18, wherein the attachment means comprises at least one of an adhesive, double sided tape, a loop fastener, a pile fastener, a magnet, magnetized sheeting, magnetic tape, a screw, a snap, and fastening tape.

20. The device of claim 18, wherein the device is at least one of removably attached and permanently attached.

21. The device of claim 1, wherein the device includes a mechanism for holding the device with respect to a surface.

22. The device of claim 21, wherein said mechanism for holding the device with respect to a surface is a hole in the device.

23. The device of claim 22, wherein said hole includes a grommet.

24. The device of claim 23, wherein said mechanism for holding the device with respect to a surface is a hanging extension.

25. The device of claim 1, wherein the device includes a mechanism to carry another item.

26. The device of claim 25, wherein said mechanism to carry another item comprises adhesive to adhere said another item to the device.

27. The device of claim 25, wherein said mechanism to carry another item comprises shrink wrap or an overlaminating material to hold said another item to the device

28. The device of claim 25, wherein said another item is a coupon, a business card, a credit card, or a refrigerator magnet.

29. A method of delivering an advertisement device by direct mail delivery to a recipient, comprising:
(i) printing an advertisement on a panel of said advertisement device, said advertisement device having a back side, a front side, at least one of said back side or said front side adapted to receive delivery information, and a thickness sufficient to maintain integrity of the panel;
(ii) applying the delivery information to at least one of said front side or said back side of said panel, and
(iii) delivering said advertising device to a recipient by direct mail delivery, wherein said panel includes an anti-microbial agent.

30. The method of claim 29, further comprising printing the delivery information directly on a surface of at least one of said front side and said back side of said panel.

31. The method of claim 29, further comprising printing the delivery information on a separate mailing label and applying said mailing label to a surface of at least one of said front side or said back side of said panel.

32. The method of claim 29, further comprising printing on at least one side of said panel a theme related to at least one of a product and a service.

33. The method of claim 32, wherein an ink used for printing said theme includes said anti-microbial agent.

34. The method of claim 32, further comprising making a cutout embedded in said panel.

35. The method of claim 34, further comprising making a cutout relating to at least one of a theme of a product and a service.

36. The method of claim 34, further comprising a cutout following an outline of the print pattern.

37. The method of claim 29, further comprising making said panel.

38. The method of claim 37, further comprising applying a coating to at least one surface of said panel, said coating comprising said anti-microbial agent.

39. The method of claim 38, further comprising applying said coating to substantially all surfaces of said panel.

40. The method of claim 29, further comprising attaching the device to a surface.

41. The method of claim 40, wherein attaching the device to a surface comprises at least one of removably attaching and permanently attaching.

42. The method of claim 29, further comprising implementing a mechanism on the advertising device for holding the advertising device with respect to a surface.

43. The method of claim 42, wherein said mechanism for holding the device with respect to a surface is a hole in the advertising device.

44. The method of claim 43, wherein said hole includes a grommet.

45. The method of claim 42, wherein said mechanism for holding the device with respect to a surface is a hanging extension.

46. The method of claim 29, further comprising implementing a mechanism on the advertising device to carry another item.

47. The method of claim 46, wherein said mechanism to carry another item comprises adhesive to adhere said another item to the advertising device.

48. The method of claim 46, wherein said mechanism to carry another item comprises shrink wrap or overlaminating material to hold said another item to the advertising device

49. The method of claim 46, wherein said another item is a coupon, a business card, a credit card, or a refrigerator magnet.

50. An advertisement device system for direct mail delivery to a recipient, comprising:
(i) a panel having a back side, a front side, at least one of said back side and said front side adapted to receive delivery information, and a thickness sufficient to maintain integrity of the panel; and
(ii) means for applying delivery information on said front side of said panel, wherein said panel includes an anti-microbial agent.

51. The system of claim 50, wherein said means for applying the delivery information comprises at least one of silk screening, sheet fed printing, web offset printing, web letter press printing, gravure printing, and ink jet printing.

52. The system of claim 50, wherein said means for applying the delivery information comprises preprinting the delivery information on a separate mailing label and applying the label to said front side or said back side of said panel.

53. The system of claim 50, wherein said panel comprises a theme related to at least one of a product and a service.

54. The system of claim 53, wherein said panel has at least one of a printed pattern related to the theme of the product or the service, and a cutout embedded in said panel related to the theme of the product or the service.

55. The system of claim 54, wherein an ink used for said printed pattern includes said anti-microbial agent.

56. The system of claim 54, wherein said cutout is die cut.

57. The system of claim 54, wherein said cutout is knife cut.

58. The system of claim 57, wherein said cutout is implemented when said panel is manufactured.

59. The system of claim 54, wherein said cutout follows the outline of the print pattern.

60. The system of claim 50, further comprising a means to attach the device to a surface.

61. The system of claim 60, wherein the attachment means comprises at least one of an adhesive, double sided tape, a loop fastener, a pile fastener, a magnet, magnetized sheeting, magnetic tape, a screw, a snap, and fastening tape.

62. The system of claim 61, wherein the device is at least one of removably attached and permanently attached.

63. The system of claim 50, wherein said panel further comprises a coating on at least one surface thereof, and said coating includes said anti-microbial agent.

64. The system of claim 63, wherein said panel comprises said coating on substantially all surfaces thereof.

65. The device of claim 50 wherein the panel includes a mechanism for holding it with respect to a surface.

66. The device of claim 65, wherein said mechanism for holding the panel with respect to a surface is a hole in the device.

67. The device of claim 66, wherein said hole includes a grommet.

68. The device of claim 65, wherein said mechanism for holding the panel with respect to a surface is a hanging extension.

69. The device of claim 50, wherein said panel includes a mechanism to carry another item.

70. The device of claim 69, wherein said mechanism to carry another item comprises adhesive to adhere said another item to the panel.

71. The device of claim 69, wherein said mechanism to carry another item comprises shrink wrap or overlaminating material to hold said another item to the panel.

72. The device of claim 69, wherein said another item is a coupon, a business card, a credit card, or a refrigerator magnet.

73. A mailable device for direct mail delivery to a recipient, comprising:
a body having at least one side, said at least one side adapted to receive delivery information; and
an anti-microbial agent on said mailable device.

74. The mailable device of claim 73, wherein said delivery information is preprinted on a separate mailing labeled and applied to said at least one side of said body to receive said delivery information.

75. The mailable device of claim 73, wherein at least a portion of said body comprises a design or a pattern imprinted thereon.

76. The mailable device of claim 75, wherein an ink is used to print said design or pattern, and said ink comprises said anti-microbial agent.

77. The mailable device of claim 73, wherein said body comprises a coating on at least one surface thereof, and said coating includes said anti-microbial agent.

78. The mailable device of claim 77, wherein said body comprises said coating on substantially all surfaces thereof.

79. The mailable device of claim 73, wherein said mailable device is an envelope.

80. The mailable device of claim 73, wherein said body includes a mechanism to carry another item.

81. The mailable device of claim 80, wherein said mechanism to carry another item comprises adhesive to adhere said another item to said body.

82. The mailable device of claim 80, wherein said mechanism to carry another item comprises shrink wrap or an overlaminating material to hold said another item to said body.

83. The mailable device of claim 80, wherein said another item is a coupon, a business card, a credit card, or a refrigerator magnet.

84. A method of delivering a mailable device by direct mail delivery to a recipient, comprising:
(i) making the mailable device, said mailable device having at least one surface adaptable to receive delivery information;
(ii) applying delivery information to said at least one surface of said body;
(iii) associating an anti-microbial agent with said mailable device; and
(iii) delivering said anti-microbial agent associated mailable device to a recipient by direct mail delivery.

85. The method of claim 84, further comprising printing the delivery information directly on a surface of said at least one surface adaptable to receive delivery information.

86. The method of claim 85, further comprising printing the delivery information on a separate mailing label and applying said mailing label to said at least one surface of said body.

87. The method of claim 84, wherein an ink is used for printing a design or pattern on at least a portion of said body, and said ink includes said anti-microbial agent.

88. The method of claim 84, wherein associating said anti-microbial agent with said mailable device includes applying a coating comprising said anti-microbial agent to at least a portion of said body.

89. The method of claim 88, further comprising applying said coating to substantially all portions of said body.

90. The method of claim 84, further comprising implementing a mechanism on said body to carry another item.

91. The method of claim 90, wherein said mechanism to carry another item comprises adhesive to adhere said another item to said body.

92. The method of claim 90, wherein said mechanism to carry another item comprises shrink wrap or overlaminating material to hold said another item to said body.

93. The method of claim 90, wherein said another item is a coupon, a business card, a credit card, or a refrigerator magnet.
